(19) United States
(12) Patent Application Publication
(10) Pub. No.: US 2004/0128345 A1
(43) Pub. Date: Jul. 1, 2004

(54) Dynamic service registry

(76) Inventors: Scott H. Robinson, Portland, OR (US); Robert C. Knauerhase, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/330,597

(22) Filed: Dec. 27, 2002

(51) Int. Cl. G06F 15/16; G06F 15/173

(52) U.S. Cl. 709/203; 709/223

(57) ABSTRACT

Automatic registration and/or deregistration from a registry such as a UDDI registry based on the connectivity of a device, such as a mobile device, with an access point. Connectivity may be determined in various ways, including changing power state, entering/leaving a service area of the access point, etc. The access point may contain a registry. Registrations may be provided to a central registry serving a local or private network, and may also be propagated to a global registry. Registries may only process registrations for proximate devices, e.g., devices within the service area. Similarly, if a mobile device desires a particular service or resource, registries may only search for services or resources provided by devices proximate to the mobile device.

### FIELD OF THE INVENTION

The invention generally relates directory services, and more particularly to automating removal of stale directory service data.

### BACKGROUND

With the advent of large-scale network connectivity, e.g., interconnection between intranets, the Internet, WANs, LANs, etc. (the term “network” will be used herein to generally reference all networks types or combinations thereof), it has become increasingly difficult to locate and track networked devices, and to identify services or capabilities that may be offered by the networked devices. To facilitate locating and tracking devices and their services, various “web service” and “directory service” technologies have been implemented.

Somewhat akin to a yellow pages service, a directory service provides an environment allowing a providing device to advertise its available services, so that another device may machine search for desired services and arrange to obtain them from the providing device. The directory service may also optionally contain entries describing services offered by other devices, whose entries are also discoverable when a device searches the directory for services. The term “web services” describes a standardized way of describing, discovering, and integrating network applications, services and resources from different businesses using open standards, such as World Wide Web Consortium (W3C) and Internet Engineering Task Force (IETF) standards, including XML (Extensible Markup Language), SOAP (Simple Object Access Protocol), WSDL (Web Services Description Language), UDDI (Universal Description, Discovery and Integration), etc., over a network, such as the Internet or other network. Web services are self-contained modular applications that communicate directly with other web services, applications, or system software. Thus, for example, XML can be used to tag a web service's data, SOAP used to transfer the data, and WSDL used to describe the web service. UDDI may be used to maintain a list (also herein called database, directory or registry) of, and permit searching for, web services or other services and resources presently available on a network.

UDDI is an industry initiative utilizing a global set of registries to allow businesses to define their services, discover other businesses and services, and to share information about how the business interacts. (See www.uddi.org. As of this writing, the current UDDI specification is Version 3.0, published 19 Jul. 2002.) UDDI is intended to create a platform-independent, open framework for describing services, discovering businesses, and integrating business services. As with web services, UDDI communicates with open standards, including XML, SOAP, HTTP (HyperText Transfer Protocol) and protocols.

Unfortunately, while UDDI's global nature provides a single source for locating offered services, UDDI lacks the ability to automatically identify and remove stale entries. That is, UDDI allows a device to easily register itself and its services and resources, but UDDI expects the device to remove its data from the database when the services are no longer offered. When a device is taken offline, frequently no effort is made to remove the now-stale data from the database. According to our recent scans, for example, of the Microsoft UDDI service, at any given time it contains roughly 80% stale data. The problems inherent to stale data is exacerbated for mobile devices, since a mobile device may drop offline for various reasons, oftentimes suddenly due to lack of power reasons or movement outside a particular wireless network area, and therefore it may be impractical or not feasible for the mobile device to remove its registration data from a UDDI registry.

### BRIEF DESCRIPTION OF THE DRAWINGS

The features and advantages of the present invention will become apparent from the following detailed description of the present invention in which:

FIG. 1 illustrates an exemplary environment for automatically registering and deregistering mobile devices with a directory service.

FIG. 2 illustrates a variation of the FIG. 1 embodiment.

FIG. 3 illustrates another variation of the FIG. 1 embodiment.

FIG. 4 illustrates a flowchart according to one embodiment for automatically registering and deregistering mobile devices with a directory service database.

FIG. 5 illustrates a technique according to one embodiment for managing cached registration data.

FIG. 6 illustrates a suitable computing environment in which certain aspects of the invention may be implemented.

### DETAILED DESCRIPTION

The invention may be utilized with various directory service, web services, UDDI registries, Microsoft Corporation's NET services, and the like. In the claims, the term “registry” is intended to generally reference these various registries. However, for expository convenience, the following detailed description focuses on UDDI registries. It will be appreciated by one skilled in the art, that as times change, alternate registries or services will arise, and that the teachings herein are applicable thereto.

The phrase “mobile device” as used herein is intended to generally reference devices that are expected to change location, and includes portable computers, handheld devices, e.g., Personal Digital Assistant (PDA), telephone, tablets, etc., devices temporarily wired to an access point, as well as transportation devices that may incorporate a computer or other computing device, e.g., private or public transportation, such as bikes, automobiles, trains, cabs, etc.

The term “mobile device” is also intended to encompass the use of virtual machines (VMs) within a fixed or mobile device. A VM may be an emulated machine or emulated platform in hardware, e.g., as a mode of operation of a processor, or in software, such as in a runtime environment. The VM may include the instruction set and other platform resources and/or devices. Thus, as with a typical mobile device being free to enter and leave a particular service area, a VM may “enter” a service area by virtue of being instantiated, and “leave” the service area when it is shut-down, de-instantiated, or otherwise made unavailable. VM's may be serialized to a shared file system or shipped over the network to be migrated to, de-serialized on and hosted by a different machine. A single physical device may have multiple VMs, each independently “entering” and “leaving” a service area. VMs may also utilize a virtual network in addition to, or in lieu of, a physical network connection.

It will be appreciated by one skilled in the art that the invention may be utilized with various devices including, but not limited to, servers, workstations, desktop PCs, laptops, virtual machines, mobile devices as listed above, and the like. In the claims, the terms “device” or “devices” are intended to generally reference these various devices. However, for expository convenience, the following detailed description focuses on conventional mobile devices. It will further be appreciated by one skilled in the art, that as devices and times change, alternate devices will arise, and that the teachings herein are applicable thereto.

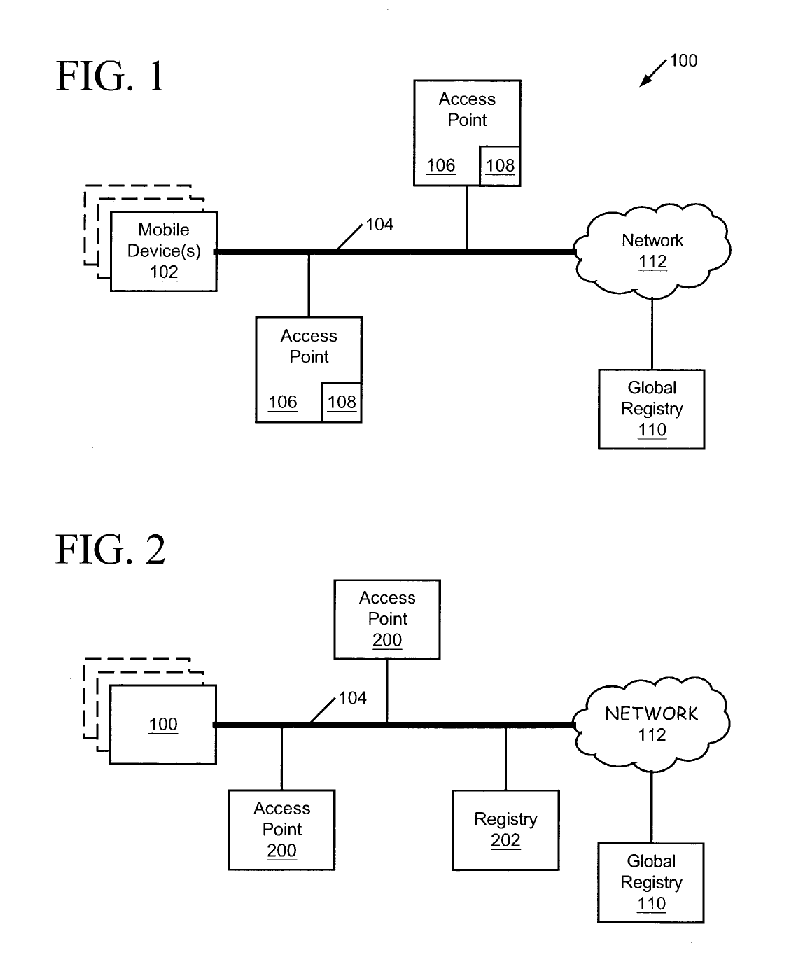

FIG. 1 illustrates an exemplary environment 100 for registering and automatically deregistering one or more (indicated by dashed lines) mobile devices 102 with directory services, such as UDDI registries maintained by a UDDI server.

In one embodiment, the device hosting the UDDI server may be pre-designated or predetermined. Such an arrangement might exist in an enterprise environment where the IT (Information Technology) staff designates particular machines as the host(s) for UDDI server(s). In one embodiment, the device hosting the UDDI server may be dynamically elected or appointed using criteria such as trust, security, available resources, owner willingness, etc. This embodiment might be more prevalent in scenarios where spontaneous or ad hoc device networks are formed in which there is not necessarily any available, pre-designated UDDI server. Devices might elect the device with the most available resources as the UDDI server.

There may be multiple UDDI registries distributed across public and private networks, each storing service registration data. The multiple registries may be kept in sync so that one may register with one UDDI registry and later retrieve registration data from another UDDI registry. Some UDDI servers are globally available. However, there are also uses for UDDI servers on private networks, such as within a given enterprise or even on a specific LAN (Local Area Network) segment or wireless cell area, or within an ad-hoc network. In these cases, multiple UDDI registries may be kept, but their contents are generally not shared with registries outside of that network domain. In the illustrated embodiment, the mobile devices 102 and directory services are communicatively coupled by way of a network 104, such as a corporate intranet. Also coupled with the network 104 are multiple access points 106 capable of sensing a connection by a mobile device.

It will be appreciated that both wired and wireless access points may be able to sense a mobile device's connection to the access point. For example, wireless access points such as those complying with one of the IEEE (Institute of Electrical and Electronics Engineers) 802.11 family of protocols, e.g., 802.11a, 802.11b, 802.11g, etc., a Bluetooth (by Bluetooth SIG, Inc.) access point, cellular telephone switch, or the like, can recognize when a mobile device operates within range of the wireless access point's transceivers. In addition, certain wired network switches, hubs, and the like are also able to determine the connectivity of a device.

In the illustrated embodiment, each access point 106 contains a UDDI (or equivalent) registry 108 to facilitate advertising, discovering, and providing/using services and resources (collectively referenced in the claims that follow as “advertise,” “advertised,” “advertising,” etc.). As noted above, there may be many UDDI registries on a network, but they need not be kept in sync as different registries may detect the absence of a device and thus automatically delete its stale registration information without having to synchronize with another registry.

In the illustrated embodiment, the access points 106 are each communicatively coupled with a global UDDI registry 110, such as the one maintained by Microsoft Corporation. The global UDDI registry may be communicatively coupled with the local network 104 by way of a second network 112, such as the Internet or other communication pathway. It will be appreciated a global registry need not be utilized, and that the invention may be practiced with a single registry configured to automatically detect and remove stale registrations.

In one embodiment, the UDDI registries 108 of the access points are configured to automatically send an update to the global UDDI registry 110 as mobile devices are attached and/or detached from the access points so that service and/or resource registrations for attaching/detaching mobile devices are appropriately added or removed from the global UDDI registry. Thus, assuming properly configured UDDI registries, if a particular device offering a certain service becomes unavailable, e.g., goes out of range of any access point, goes to sleep, etc., then the certain service registry entry associated with the particular device can be automatically removed from the registries. It will be appreciated that certain communication technologies may allow discovering impending unavailability, e.g., a transceiver may announce it is leaving a service area, and thus afford opportunity for a more graceful deregistration from the UDDI servers before a connection is lost.

In an alternate embodiment, since employing a UDDI registry in each access point 200 may be too costly (e.g. administratively or in terms of total bill of materials), as shown in FIG. 2, access points 200 instead are all communicatively coupled with a central UDDI registry 202. In this embodiment, the central UDDI registry is local to the network 104, and is configured to operate with the access points 200 as well as (optionally) a global UDDI registry 110, such as the one maintained by Microsoft Corporation. In the illustrated embodiment, the global UDDI registry is communicatively coupled with the local network 104 by way of a second network 112, such as the Internet or other communication pathway. However, since registrations within the central registry 202 are transitory, it will be appreciated that the global registry may not ever learn of services registered with the central registry 202, or may only learn of a subset thereof.

In one embodiment of FIG. 2, the access points 200 are configured to relay connectivity information for the mobile devices to the central UDDI registry 202 so that service and/or resource registrations may be updated as mobile devices are attached and removed from the access points. Thus, the central UDDI registry 202 may be dynamically updated, and be used to aggregate and serve as a matchmaker between service and/or resource providers and their consumers that are currently communicatively coupled with the access points 200.

In another embodiment, access points 300 each contain UDDI registries 302 as in FIG. 1, but they are communicatively coupled with a central UDDI registry 304 on a local network 306 as in FIG. 2. An access point's 300 UDDI registry 302 may operate to receive registration data from a mobile device, and if the device is seeking services and/or resources, may in a conventional manner indicate devices known to the access point providing the desired services and/or resources. In one embodiment, access points store only local registration data, e.g., advertised services, etc., for mobile devices connected to the access point. In this embodiment, requests for services and/or resources unknown to the access point are forwarded to the central UDDI server 304 for appropriate resolution.

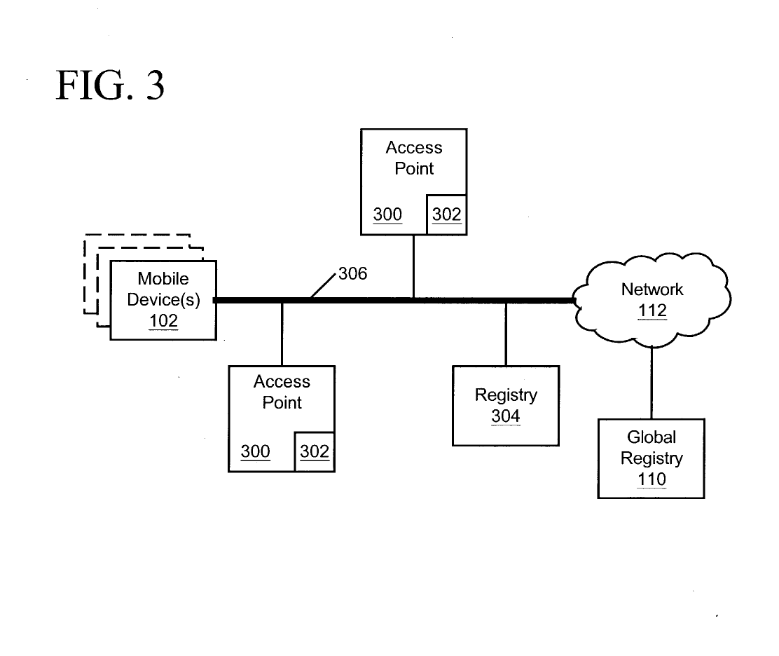

In one embodiment of the FIG. 3 embodiment, the UDDI registries 302 of the access points 300 are configured to automatically send an update to the central UDDI registry 304 as mobile devices are attached and/or detached from the access points, to allow the central registry to track advertised or requested services and/or resources on the local network 306. The central registry may also send attach/detach notifications, if needed, to a global UDDI registry.

Thus, even if an access point's registry 302 only maintains local registrations, the central UDDI registry 304 may be used to dynamically aggregate registration information from access points, and operate as a matchmaker between service and/or resource producers and their consumers if an access point is unable to directly respond to the device's needs. If a requested service and/or resource is unknown to the central server, the request may be forwarded to the global registry 308. Thus, for example, in an airport, the central registry 304 may be on a LAN for a particular airport terminal, and store registrations for static devices, such as printers, available within the terminal, while access point registries 302 track local registrations.

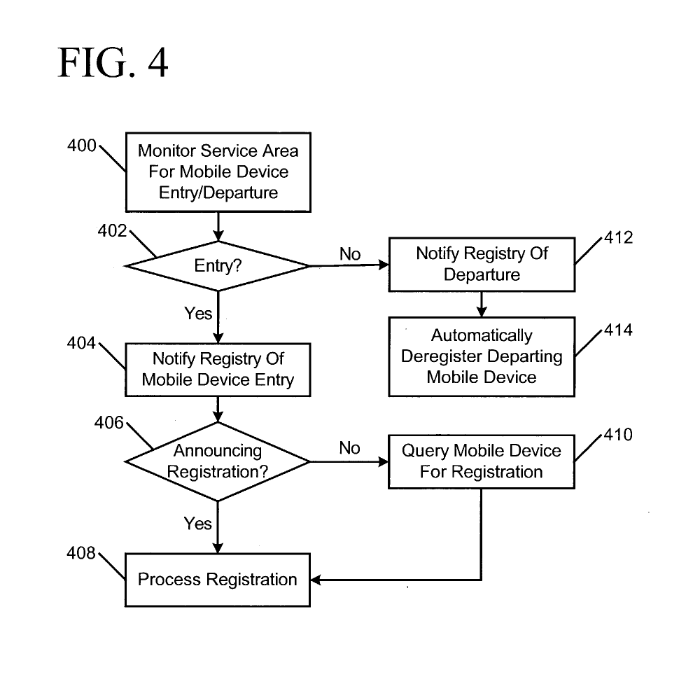

FIG. 4 illustrates a flowchart according to one embodiment for automatically registering and deregistering mobile devices with a registry, such as a UDDI registry or other directory service. This flowchart assumes the perspective of an access point that is monitoring 400 for mobile devices to enter or leave the access point's service area, e.g., in a wireless context, a mobile device comes in to or out of range of the access point, or in a wired context, the mobile device is wired to or disconnected from the access point.

If 402 a mobile device is entering the service area, e.g., comes into range of the access point's transceiver, is handed off from another access point, wakes up from a low-power or other offline state, is wired in to the access point, etc., the access point can notify 404 a registry, e.g., a UDDI registry internal or external to the access point, that the mobile device has entered the service area. Various data may be used to uniquely identify the mobile device to the registry, such as assigned IP (Internet Protocol) address, MAC (Medium Access Control) address, e.g., the hardware address uniquely identifying the mobile device's interface to the network to which the access point is providing access, GUID (globally unique identifier), processor identifier, machine name, or other identifying data. It is assumed herein that a network protocol state may be inspected to determine connectivity.

Once the mobile device is identified to the registry, in one embodiment, the registry determines if 406, the mobile device, upon being connected to the access point, is announcing or otherwise publishing services and/or resources it would like to advertise or for which to search. If so, the registry processes 408 the announcements and registers the mobile device accordingly. If not, then the registry may query 410 the mobile device in a conventional manner for services and/or resources the mobile device would like to advertise or for which to search, and register the mobile device accordingly. If the registry is internal or proximate to the access point, it will be appreciated that various rules or policies may be employed to control whether the registration is communicated to other registries. For example, an access point having an internal registry may apply a strict policy of only tracking service and/or resource advertisements/requests for devices connected thereto, and therefore not forward service and/or resource advertisements/requests to other registries.

Alternatively, regions may be defined, such that service and/or resource advertisements/requests are shared between registries within a region. A region may be defined to, for example, associate fixed assets, such as printers or the like, with access points that are proximate to the access points. Thus, a mobile device may subscribe without concern to a service since it is known to be somewhere nearby. Similarly, services and/or resources advertised by other mobile devices may be subscribed to with the knowledge that they are proximate.

If 402 the mobile device is leaving the service area, e.g., leaves the range of the access point's transceiver, is handed off to another access point, goes to sleep, loses power, is unwired from the access point, etc., in one embodiment, the access point can notify 412 the registry, e.g., the internal or external registry associated with the access point, that the mobile device has left the service area. The registry may then deregister 414 the mobile device to prevent stale entries from remaining within the registry. In another embodiment, rather than requiring the registry to be configured to respond to the departure notification 412, instead the access point can issue appropriate deregistration commands to the registry, thus allowing backwards compatibility with conventional registries. Thus, deregistration from a registry may be automatically effected even if the registered mobile device is unable to perform deregistration because it has gone to sleep, lost power, etc.

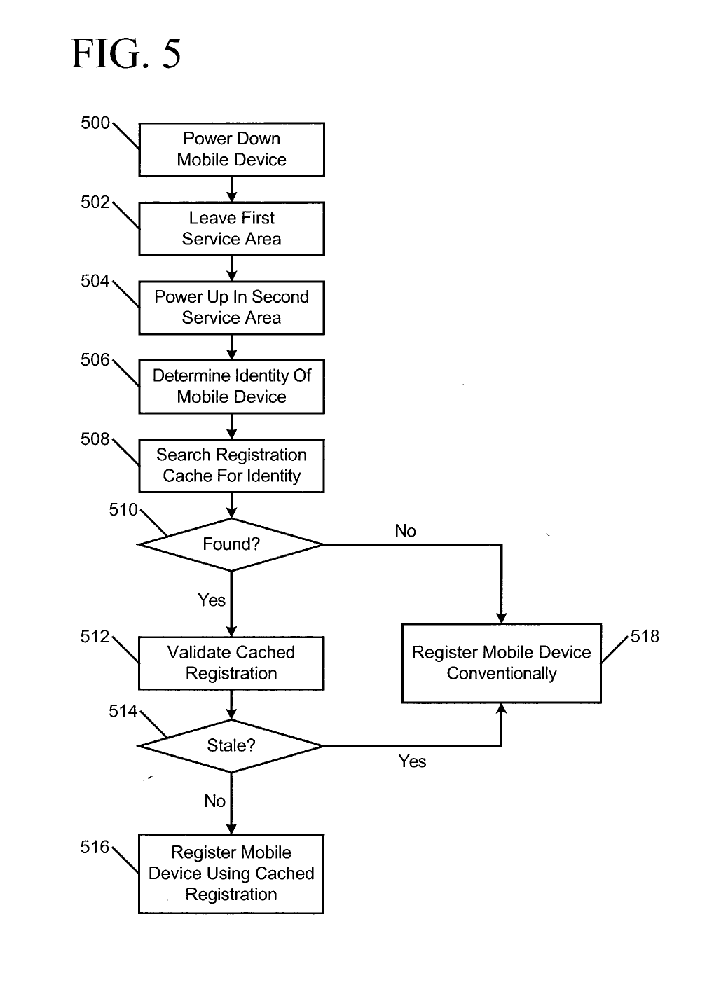

Since mobile devices may alternate between availability and unavailability, various well-known caching and cache coherency schemes may be employed to simplify reregistering a device with a registry, after it comes back into contact again with one of the access points. For example, as illustrated in FIG. 5, assume a mobile device powers down 500, leaves 502 the service area for a first access point and then powers on 504 in a new service area for a second access point. In one embodiment, the second access point determines 506 an identity for the mobile device, e.g., the data used to uniquely identify the mobile device to the registry, and searches 508 a registration cache for the identity. It will be appreciated that the first and second access points may share a registration cache or have separate caches kept in sync. If 510 the identity is found, the cached information is validated 512 to ensure it is not stale. In one embodiment, the mobile device may save a previously determined identity and provide it to an access point to facilitate its searching its cache for a cached registration for the mobile device.

There are many known cache validation techniques, including comparing a first hash value provided by the mobile device for registration data it would present to the registry if required, with a second hash value computed for the cached registration. If 514 the cached registration is not stale, then it is used to register 516 the mobile device with a registry associated with the second access point, e.g., registries 108, 202, 302, 304. If the If 514 the cached registration is stale, or if 510 the identity was not found, then the mobile device is registered 518 conventionally, e.g., queried for advertised and/or requested services and/or resources. Other cache update mechanisms that use similar methods, but over finer granularities, might also be employed to only refresh those portions of the registry that must be updated as well as differential methodologies (e.g. only send change records for things that have been updated since the last publish time of the device).

Various policies and/or rules may be applied to determine when to delete a registration from a cache (or from a registry). For example, a strict policy would be to delete a registration as soon as a device becomes unavailable, e.g., leaves the services area for an access point. Another policy could be to attempt a “Wake on LAN” event before deleting a registration (possibly after some lease time has expired), in which case if the mobile device cannot be revived, then its registration is removed. Another policy could be to require a mobile device to leave its radio on, even if in a substantially reduced capacity, e.g., only maintaining a heartbeat signal. If the heartbeat goes away, then the registration is deleted. Since the mobile devices typically lease a network address from an access point, another (lax) policy could be to check for the presence of the mobile device when the lease is up for renewal, and if the device is not found, then its registration is deleted.

Note that even if a registration is deleted as illustrated in FIG. 4, registration caching may be used to limit power consumption by a returning mobile device. When the mobile device becomes available, it may conserve its power if a cached registration may be used to register it with a registry. It will be appreciated that the extent to which a mobile device can avoid using its radio, such as in avoiding lengthy cross-talk inherent to registrations, this may result in significant power savings and reduced network traffic.

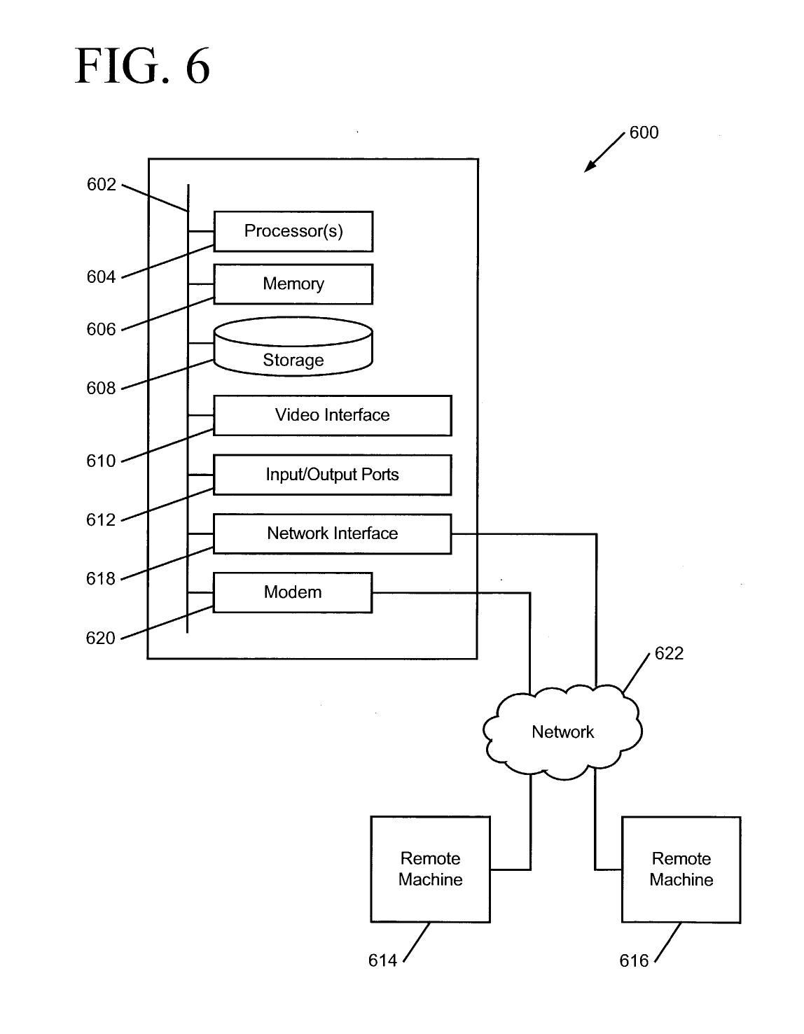

FIG. 6 and the following discussion are intended to provide a brief, general description of a suitable environment in which certain aspects of the illustrated invention may be implemented. As used herein below, the term “machine” is intended to broadly encompass a single machine, or a system of communicatively coupled machines or devices operating together. Exemplary machines include FIG. 1 mobile devices 100, as well as virtual machines, personal computers, workstations, servers, etc.

Typically, the environment includes a machine 600 that includes a system bus 602 to which is attached processors 604, a memory 606, e.g., random access memory (RAM), read-only memory (ROM), or other state preserving medium, storage devices 608, a video interface 610, and input/output interface ports 612. The machine may be controlled, at least in part, by input from conventional input devices, such as keyboards, mice, etc., as well as by directives received from another machine, interaction with a virtual reality (VR) environment, biometric feedback, or other input source or signal.

The machine may include embedded controllers, such as programmable or non-programmable logic devices or arrays, Application Specific Integrated Circuits, embedded computers, smart cards, and the like. The machine may utilize one or more connections to one or more remote machines 614, 616, such as through a network interface 618, modem 620, or other communicative coupling. Machines may be interconnected by way of a physical and/or logical network 622, such as the network 104 of FIG. 1, an intranet, the Internet, local area networks, and wide area networks. One skilled in the art will appreciated that communication with network 622 may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, volatile and/or non-volatile memory 606, or in storage devices 608 and their associated storage media, including hard-drives, floppy-disks, optical storage, tapes, flash memory, memory sticks, digital video disks, biological storage, etc. Associated data may be delivered over transmission environments, including network 622, in the form of packets, serial data, parallel data, propagated signals, etc., and may be used in a compressed or encrypted format. Associated data may be used in a distributed environment, and stored locally and/or remotely for access by single or multi-processor machines.

Thus, for example, with respect to the illustrated embodiments, assuming machine 600 embodies a dynamically updated UDDI Web Service Registry associated with a “hotspot” (i.e. an area or cell of wireless networking coverage) in an airport's wireless network, then remote machine 614 may be a permanent device, such as a server, display device, printers, etc. installed at the airport, and remote machine 616 may be a transient wireless device, such as a laptop computer, handheld device, etc. passing through the airport. It will be appreciated that remote machines 614, 616 may be include many or all of the elements discussed for machine 600, and that both the transient and permanent devices may wish to advertise, discover, and provide/use services and resources of the other. A dynamically updated central registry service can be used to aggregate and match service and/resource producers with consumers. And, although the foregoing discussion has focused on use of access points that coordinate registration and deregistration from a UDDI registry, it should be appreciated that an access point is not required, as the principles disclosed herein may be applied to an ad hoc network (e.g. every device could have its own UDDI server).

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method for registering devices with a first registry, the first registry being searchable for registrants advertising a service or a resource, the method comprising:
monitoring a service area for entry of a device within the service area;
determining a service or resource advertised by the device;
automatically registering the device with the first registry, the registering including creating a registration for the device identifying the advertised service or resource.

2. The method of claim 1, further comprising:
automatically deregistering the device from the first registry

3. The method of claim 2, further comprising:
automatically deregistering the device from the first registry responsive to one or more of the following state changes for the device: going to sleep, losing power, rebooting, and leaving the service area.

4. The method of claim 1, further comprising:
an access point communicatively coupling the device and the first registry; and
automatically deregistering the device from the first registry if the access point loses communication with the device.

5. The method of claim 1, further comprising:
an access point providing the device with a communication address having an expiration; and
automatically deregistering the device from the first registry if the device is unavailable to communicate with the access point on the expiration of the communication address.

6. The method of claim 5, further comprising:
automatically extending the expiration.

7. The method of claim 1, further comprising:
performing the method with an access point.

8. The method of claim 7, further comprising:
disposing the first registry within the access point.

9. The method of claim 1, further comprising:
disposing the first registry within an access point for devices; and
only automatically registering the device if attached to the access point.

10. The method of claim 1, wherein the registration is short-lived.

11. The method of claim 1, wherein advertising the service or resource comprises the device offering the service or resource for use by other devices.

12. The method of claim 1, wherein advertising the service or resource comprises the device identifying a service or resource desired from another device.

13. The method of claim 1, further comprising:
searching the first registry for the advertised service or resource.

14. The method of claim 1, wherein the first registry comprises a selected one of a UDDI service directory or other directory of services”?

15. The method of claim 1, further comprising:
detecting whether the device, on entering the service area, announced the service or resource advertised by the device.

16. The method of claim 1, further comprising:
querying the device, on its entering its the service area, for the service or resource advertised by the device.

17. The method of claim 1, further comprising:
determining whether the service or resource advertised by the device is unavailable from another device within the service area.

18. A system, comprising:
a device operable to advertise a service or a resource;
a first registry, the registry being searchable for registrants advertising services or resources; and
a first access point communicatively coupled with both the device and the first registry, the access point having a service area, wherein the first access point is operable to perform:
monitoring the service area for entry therein of the device;
determining a service or resource advertised by the device; and
automatically registering the device with the first registry.

19. The system of claim 18, wherein the first registry is disposed within the first access point.

20. The system of claim 19, further comprising: a second access point;
a second registry disposed within the second access point and being searchable for registrants advertising services or resources; and
a private network communicatively coupling the first and second access points.

21. The system of claim 18, further comprising:
a second access point; and
a private network communicatively coupling the first and second access points;
wherein the first registry is searchable only for services or resources advertised by devices coupled with the first access point.

22. The system of claim 18, further comprising:
a public network communicatively coupled with a global registry; and
a private network communicatively coupled with both the access point and the public network.

23. The system of claim 22, further comprising:
a second access point communicatively coupled with the private network;
wherein the first registry is communicatively coupled with but separate from both the first and second access points.

24. An article comprising a machine-accessible media having associated data, wherein the data, when accessed, results in a machine performing:
monitoring a service area for entry of a device within a service area of a first registry, the first registry being searchable for registrants advertising a service or a resource;
determining a service or resource advertised by the device;
automatically registering the device with the first registry, the registering including creating a registration for the device identifying the advertised service or resource.

25. The article of claim 24 wherein the machine-accessible media further includes data, when accessed, results in the machine performing:
automatically deregistering the device from the first registry.
